(19) United States
(12) Patent Application Publication
(10) Pub. No.: US 2026/0254380 A1
(43) Pub. Date: Aug. 27, 2026

(54) POWER TOOL INCLUDING A SHAFTLESS MOTOR

(71) Applicant: MILWAUKEE ELECTRIC TOOL CORPORATION, Brookfield, WI (US)

(72) Inventor: Luis F. Gonzalez Jauregui, Milwaukee, WI (US)

(21) Appl. No.: 19/550,785

(22) Filed: Feb. 26, 2026

Related U.S. Application Data
(60) Provisional application No. 63/764,028, filed on Feb. 27, 2025.

(51) Int. Cl. H02P 21/00; H02K 1/2792; H02K 5/24; H02K 7/14; H02K 11/21; H02P 21/12

(52) U.S. Cl. CPC H02P 21/0089; H02K 1/2792; H02K 5/24; H02K 7/14; H02K 11/21; H02P 21/12

(57) ABSTRACT

A method for controlling a motor that includes a rotor having a Halbach magnet array and a stator in electromagnetic communication with the rotor, include sensing, via a position sensor, a position of the rotor, generating, via the position sensor, rotor position data, determining, via an electronic processor, a commutation angle for each of a plurality of phases of the stator based on the rotor position data, dynamically controlling, via the electronic processor, the commutation angle of the motor by selectively advancing or delaying conduction intervals of each phase, dynamically controlling, via the electronic processor, a phase advance angle of the motor by modulating the phase advance angle of a motor current relative to a rotor magnetic field, receiving, an operating parameter, and applying, a combined field weakening by implementing the dynamically controlled commutation angle and the dynamically controlled phase advance angle in response to the operating parameter.

### RELATED APPLICATIONS

This application claims the benefit of U.S. Provisional Patent Application No. 63/764,028, filed Feb. 27, 2025, the entire content of which is hereby incorporated by reference.

### FIELD

Embodiments described herein relate to electric power tools.

### SUMMARY

Power tools described herein include a motor including a stator having an inner configuration, stator windings wound around stator teeth, a rotor mounted for rotation relative to the stator, a fan rotor coupled to the rotor, a mounting bracket configured to attach the motor to the power tool, a position sensor configured to sense a position of the rotor and to generate rotor position data, and an electronic processor. The rotor includes rotor magnets positioned on the rotor in a magnet array. The magnet array includes magnetically perpendicular magnets arranged between rotor magnets such that a first magnetic field on an inner side of the rotor is greater than a second magnetic field on an outer side of the rotor. The fan rotor includes fan blades, a fan dome, and rotor bearings supported by the fan dome. The electronic processor is connected to the motor and the position sensor. The electronic processor is configured to determine a commutation angle for each of a plurality of phases of the stator based on the rotor position data, dynamically control the commutation angle of the motor by selectively advancing or delaying conduction intervals of each phase, dynamically control a phase advance angle of the motor by modulating the phase advance angle of a motor current relative to a magnetic field of the magnet array, receive an operating parameter of the power tool, and apply a combined field weakening to the motor by implementing the dynamically controlled commutation angle and the dynamically controlled phase advance angle in response to the operating parameter.

Power tools described herein include a motor including a stator and a rotor. The stator has an inner configuration. The stator includes a plurality of stator windings wound around a plurality of stator teeth. The rotor is mounted for rotation relative to the stator. The rotor includes rotor magnets positioned on the rotor in a magnet array. The magnet array includes magnetically perpendicular magnets arranged between adjacent rotor magnets such that a first magnetic field on an inner side of the rotor is greater than a second magnetic field on an outer side of the rotor. The rotor includes a plurality of fan blades, a fan dome, and rotor bearings supported by the fan dome. A mounting bracket is configured to attach the motor to the power tool. A position sensor is configured to sense a position of the rotor and to generate rotor position data. An electronic processor is connected to the motor and the position sensor. The electronic processor is configured to determine a commutation angle for each of a plurality of phases of the stator based on the rotor position data, dynamically control the commutation angle of the motor by selectively advancing or delaying conduction intervals of each phase, dynamically control a phase advance angle of the motor by modulating the phase advance angle of a motor current relative to a magnetic field of the magnet array, receive an operating parameter of the power tool, and apply a combined field weakening to the motor by implementing the dynamically controlled commutation angle and the dynamically controlled phase advance angle in response to the operating parameter.

Methods of controlling a motor. The motor includes a rotor having a Halbach magnet array and a stator in electromagnetic communication with the rotor. The methods include sensing, via a position sensor, a position of the rotor, generating, via the position sensor, rotor position data, determining, via an electronic processor, a commutation angle for each of a plurality of phases of the stator based on the rotor position data, dynamically controlling, via the electronic processor, the commutation angle of the motor by selectively advancing or delaying conduction intervals of each phase, dynamically controlling, via the electronic processor, a phase advance angle of the motor by modulating the phase advance angle of a motor current relative to a rotor magnetic field, receiving, via the electronic processor, an operating parameter, and applying, to the motor and via the electronic processor, a combined field weakening by implementing the dynamically controlled commutation angle and the dynamically controlled phase advance angle in response to the operating parameter.

Motors described herein include a stationary support structure configured to be coupled to a housing and a stator mounted to the stationary support structure. The stator includes a plurality of stator teeth and a plurality of stator windings wound around the plurality of stator teeth. An outer rotor is configured to rotate relative to the stator. The outer rotor has at least one bearing positioned between the stationary support structure and the outer rotor to rotatably support the rotor, and a Halbach magnet array coupled to an inner surface of the outer rotor. The Halbach magnet array includes a first magnet configured to generate a first magnetic field, and a second magnet arranged adjacent the first magnet. The second magnet is magnetically perpendicular to the first magnet. The Halbach magnet array is configured to concentrate a magnetic flux radially toward the stator windings and substantially cancel the magnetic flux radially away from the stator.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively. Other aspects of the embodiments will become apparent by consideration of the detailed description and accompanying drawings.

### BRIEF DESCRIPTION OF THE DRAWINGS

FIG. 1A illustrates a power tool, in accordance with embodiments described herein.

FIG. 1B illustrates a control system for the power tool of FIG. 1A, in accordance with embodiments described herein.

FIG. 2A illustrates a motor in connection with the control system of the power tool of FIG. 1A, in accordance with embodiments described herein.

FIG. 2B illustrates an alternative view of the motor in connection with the control system of the power tool of FIG. 1A, in accordance with embodiments described herein.

FIG. 2C illustrates an alternative view of the motor in connection with the control system of the power tool of FIG. 1A, in accordance with embodiments described herein.

FIG. 2D illustrates an alternative view of the motor in connection with the control system of the power tool of FIG. 1A, in accordance with embodiments described herein.

FIG. 3A is a graph illustrating the performance characteristics of a motor, in accordance with embodiments described herein.

FIG. 3B is legend for the graph of FIG. 3A, in accordance with embodiments described herein.

FIG. 4 is a graph illustrating the performance characteristics of a power tool, in accordance with embodiments described herein.

FIG. 5 is a graph illustrating the performance characteristics of a power tool, in accordance with embodiments described herein.

FIG. 6 is a graph illustrating the performance characteristics of a power tool, in accordance with embodiments described herein.

FIG. 7 is a graph illustrating the performance characteristics of a power tool, in accordance with embodiments described herein.

FIG. 8 is a graph illustrating the performance characteristics of a power tool, in accordance with embodiments described herein.

FIGS. 9A, 9B, and 9C are graphs illustrating the performance characteristics of a motor, in accordance with embodiments described herein.

FIG. 10 illustrates a cross-sectional view of a motor, in accordance with embodiments described herein.

FIGS. 11A and 11B illustrate an arrangement of magnets of a motor, in accordance with embodiments described herein.

FIG. 12A is a graph illustrating the performance characteristics of a motor, in accordance with embodiments described herein.

FIG. 12B is legend for the graph of FIG. 12A, in accordance with embodiments described herein.

FIG. 13 is a graph illustrating the performance characteristics of a motor, in accordance with embodiments described herein.

FIG. 14 is a graph illustrating the performance characteristics of a motor, in accordance with embodiments described herein.

FIG. 15 is a flowchart of a process of controlling a motor, in accordance with embodiments described herein.

### DETAILED DESCRIPTION

Embodiments described herein relate to motor configurations and methods of motor control in a power tool. For example, a Halbach motor includes a specialized arrangement of permanent magnets, referred to herein as a Halbach array, to concentrate magnetic flux on one side of a motor rotor while nearly canceling it out on the other side of the motor rotor. By rotating the magnetization direction of each adjacent magnet segment, the Halbach array intensifies the magnetic field in one direction while minimizing stray fields in the opposite direction. In contrast to conventional magnet arrangements that produce fields on both sides equally (e.g., a regular motor construction), a Halbach array channels more magnetic energy into the working space of the motor. When configured in a shaftless, coreless fan motor designs, such as those described herein, the rotor resides at the outer perimeter and the stator coils are arranged in an inner configuration. This arrangement may reduce weight and core losses, improving efficiency and torque density.

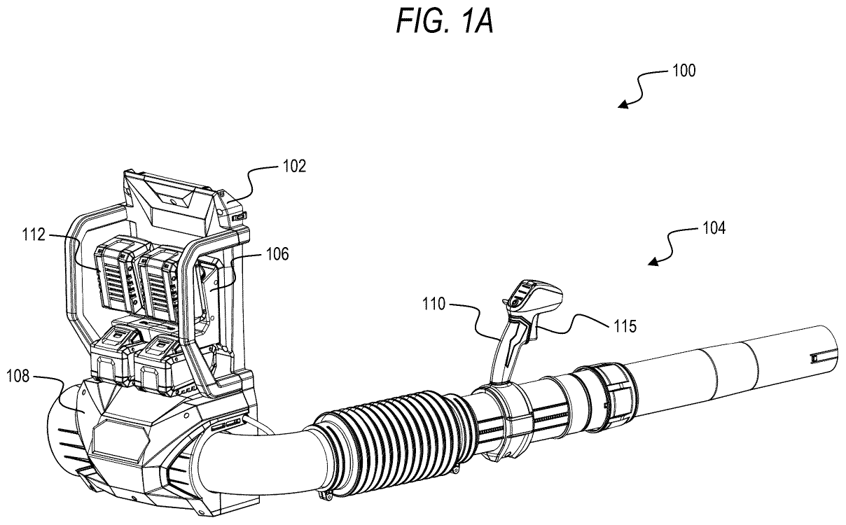

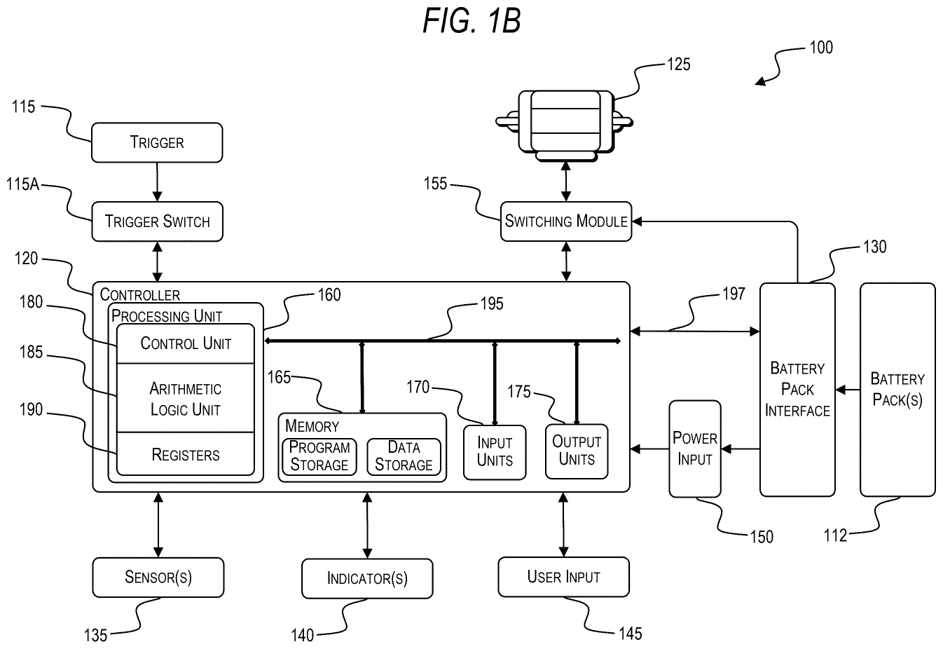

FIG. 1A illustrates a battery pack powered power tool 100. In the illustrated embodiment, the power tool 100 is as a blower. However, in other embodiments, the power tool 100 may be another power tool (e.g., a drill/driver, an impact tool, a saw, a chainsaw, a mower, a trimmer, etc.). The power tool 100 includes a backpack portion 102 that can be worn by an operator and an arm portion 104 coupled to the backpack portion 102. The backpack portion 102 includes a plurality of battery pack receptacles 106 and a blower 108. The plurality of battery receptacles can each receive a removable and rechargeable battery pack 112. The arm portion 104 includes a handle 110 mounted to a rigid conduit for controlling operation of the power tool 100. The handle 110 can include a trigger 115.

FIG. 1B illustrates a control system for the power tool 100. The control system can be part of or otherwise connected to a printed circuit board (“PCB”) and can include a controller 120. The controller 120 is electrically and/or communicatively connected to a variety of modules or components of the power tool. For example, the illustrated controller 120 is electrically connected to a motor 125, a battery pack interface 130 (connectable to battery pack 112 or a plurality of battery packs 112 via a plurality of battery pack receptacles or interfaces), a trigger switch 115A (connected to trigger 115), one or more sensors 135 or sensing circuits, one or more indicators 140, a user input module 145, a power input module 150, and a switching module or field effect transistor (“FET”) switching module 155 (e.g., including a plurality of switching FETs). The controller 120 includes combinations of hardware and software that are operable to, among other things, control the operation of the power tool, monitor the operation of the power tool, control switching between the plurality of battery packs, monitor the operation of the plurality of battery packs, activate the one or more indicators 140 (e.g., an LED), etc.

In some embodiments, each battery pack 112 includes any number of battery cells. The battery cells can be arranged in series, parallel, or a series-parallel combination. In some embodiments, each battery pack 112 includes a number of battery cells (e.g., between 3 and 50 battery cells) connected in series, parallel, or a series-parallel combination in order to produce a battery pack having a desired combination of nominal battery pack voltage and battery capacity.

The battery cells can be lithium-based battery cells having a chemistry of, for example, lithium-cobalt (“Li—Co”), lithium-manganese (“Li—Mn”), or Li—Mn spinel. In some embodiments, the battery cells have other suitable lithium or lithium-based chemistries, such as a lithium-based chemistry that includes manganese, etc. The battery cells within each battery pack 112 provide operational power (e.g., voltage and current) to the power tool 100. In some embodiments, each battery cell has a nominal voltage of approximately 3.6V, such that the battery pack has a nominal voltage of approximately 18V. In other embodiments, the battery cells have different nominal voltages, such as, for example, between 3.6V and 4.2V, and the battery pack has a different nominal voltage, such as, for example, 10.8V, 12V, 14.4V, 24V, 28V, 36V, 72V, 80V, 120V, 150V, between 10.8V and 150V, etc. The battery cells also have a capacity of, for example, between approximately 1.0 ampere-hours (“Ah”) and 10.0 Ah. In exemplary embodiments, the battery cells have capacities of approximately, 1.5 Ah, 2.4 Ah, 3.0 Ah, 4.0 Ah, 5.0 Ah, 10.0 Ah, between 1.5 Ah and 10.0 Ah, etc.

The controller 120 includes a plurality of electrical and electronic components that provide power, operational control, and protection to the components and modules within the controller 120 and/or the power tool 100. For example, the controller 120 includes, among other things, a processing unit 160 (e.g., a microprocessor, a microcontroller, electronic processor, electronic controller, or another suitable programmable device), a memory 165, input units 170, and output units 175. The processing unit 160 includes, among other things, a control unit 180, an arithmetic logic unit (“ALU”) 185, and a plurality of registers 190 (shown as a group of registers in FIG. 1B), and is implemented using a known computer architecture (e.g., a modified Harvard architecture, a von Neumann architecture, etc.). The processing unit 160, the memory 165, the input units 170, and the output units 175, as well as the various modules or circuits connected to the controller 120 are connected by one or more control and/or data buses (e.g., common bus 195). The control and/or data buses are shown generally in FIG. 1B for illustrative purposes. The use of one or more control and/or data buses for the interconnection between and communication among the various modules, circuits, and components would be known to a person skilled in the art in view of the embodiments described herein.

The memory 165 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 160 is connected to the memory 165 and executes software instructions that are capable of being stored in a RAM of the memory 165 (e.g., during execution), a ROM of the memory 165 (e.g., on a generally permanent basis), or another non-transitory computer readable medium such as another memory or a disc. Software included in the implementation of the power tool 100 can be stored in the memory 165 of the controller 120. The software includes, for example, firmware, one or more applications, program data, filters, rules, one or more program modules, and other executable instructions. The controller 120 is configured to retrieve from the memory 165 and execute, among other things, instructions related to the control processes and methods described herein. In other constructions, the controller 120 includes additional, fewer, or different components.

The battery pack interface 130 includes a combination of mechanical components (e.g., rails, grooves, latches, etc.) and electrical components (e.g., one or more terminals) configured to and operable for interfacing (e.g., mechanically, electrically, and communicatively connecting) the power tool with one or more battery pack (e.g., a plurality of battery packs). For example, power provided by each battery pack to the power tool 100 is provided through the battery pack interface 130 to the power input module 150 and/or the switching module 155. The power input module 150 includes combinations of active and passive components to regulate or control the power received from each battery pack prior to power being provided to the controller 120. The battery pack interface 130 also supplies power to the switching module 155 to be switched by the switches to selectively provide power to the motor 125. The battery pack interface 130 also includes, for example, a communication line 197 for providing a communication line or link between the controller 120 and each battery pack 112.

The indicators 140 include, for example, one or more light-emitting diodes (“LEDs”). The indicators 140 can be configured to display conditions of, or information associated with, the power tool 100. For example, the indicators 140 are configured to indicate measured electrical characteristics of the power tool 100 and/or the battery pack 112, the status of the battery packs 112, etc. In some embodiments, the indicators 140 are located on a user interface (e.g., a graphical user interface) of the power tool 100. The user input module 145 is operably coupled to the controller 120 to, for example, select a forward mode of operation or a reverse mode of operation, a torque and/or speed setting for the power tool (e.g., using torque and/or speed switches), etc. In some embodiments, the user input module 145 includes a combination of digital and analog input or output devices required to achieve a desired level of operation for the power tool, such as one or more knobs, one or more dials, one or more switches, one or more buttons, etc.

In some embodiments, the controller 120 controls commutation of the motor 125 with a predefined excitation frequency and amplitude without closed-loop feedback. This method of control is referred to as open loop. In some examples, a dynamically adjusted phase angle (“DPA”) control, by contrast, continuously shifts the current phase of the motor 125 relative to the voltage to optimize torque and manage field weakening under varying speeds or loads. DPA control involves using the controller 120 to actively modulate the phase relationship between the stator 230 current and the rotor 205 magnetic field to optimize torque generation and efficiency. DPA control may increase torque output at lower speeds or weaken the field at higher speeds, reducing back-EMF and allowing the motor to sustain higher RPM with a given supply voltage.

In some embodiments, a dynamically adjusted commutation angle (“DCA”) method is used, based on real-time rotor position and motor phase current measurements, detected via sensors 135 (or sensorless methods). DCA control is enabled by altering the timing of each motor phase switching event relative to the rotor 205's position. DCA modifies the electrical conduction boundaries such that each stator winding is energized at the most beneficial rotor angle. DCA control contrasts with DPA control, which uses the controller 120 to fine-tune the phase of the current vector relative to the rotor magnetic field.

In some examples, a dynamically adjusted phase angle and commutation angle (“DPA+DCA”) method is used, enabling a more comprehensive control that can balance torque output, efficiency, and thermal performance across a broad operating range. A combined dynamically adjusted phase angle and commutation angle control method provides greater flexibility than the previously described phase angle or commutation angle methods, shifting the stator current vector phase continuously while also fine-tuning the commutation timing. Using both DPA+DCA control, the controller 120 optimizes motor 125 torque generation from precise alignment of magnetic fields (phase control) and minimizes switching losses and torque ripple from the conduction intervals (commutation control). Compared to any single method of DPA or DCA, DPA+DCA offers a higher degree of freedom to manage trade-offs between performance, efficiency, noise, and temperature of the motor 125. The methods of commutation control and the comparison of performance between said methods are described in greater detail below.

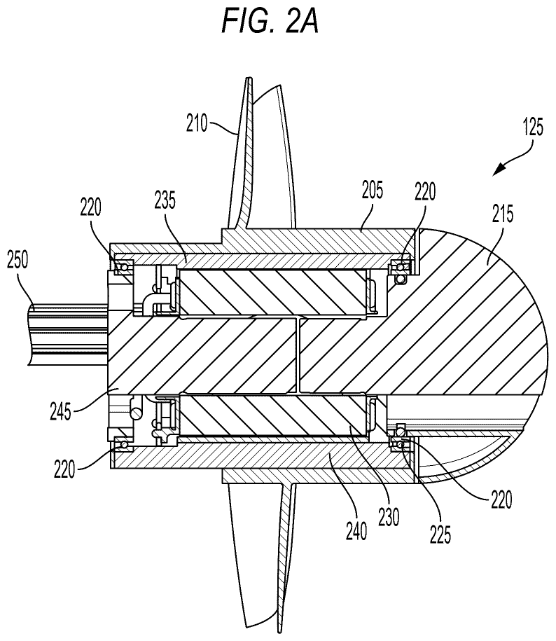

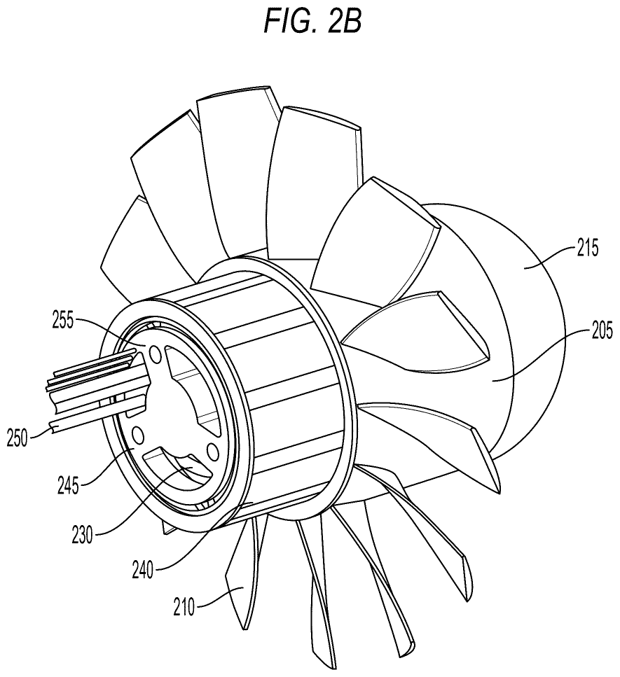

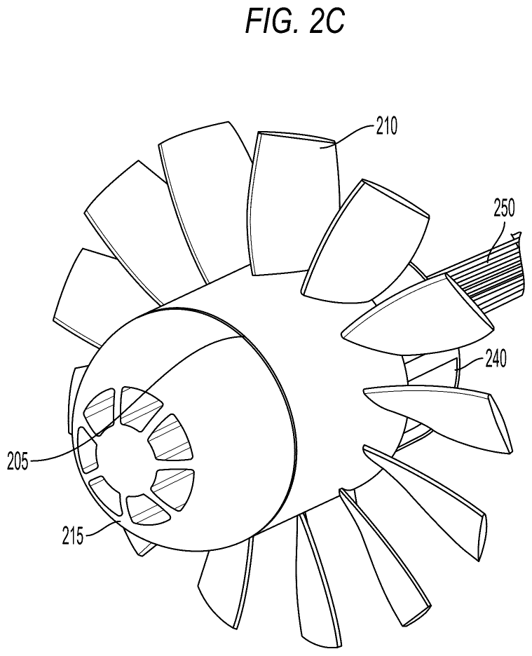

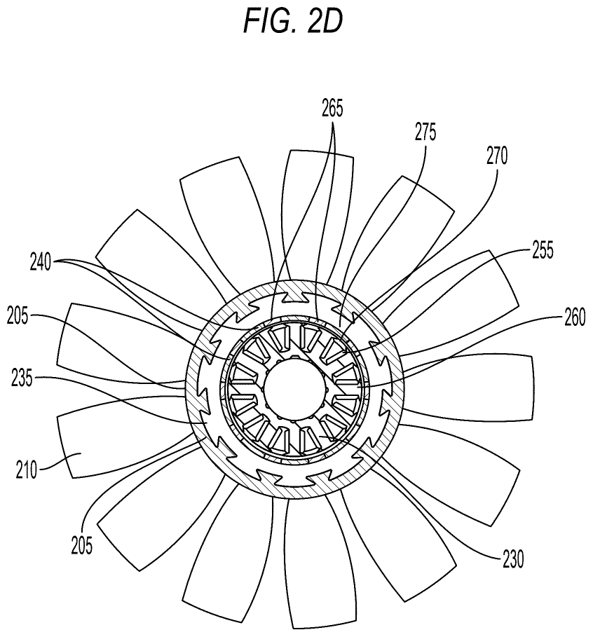

FIG. 2A-2D illustrates the motor 125 of the power tool 100 of FIG. 1A. The motor 125 includes a fan rotor or rotor 205 having fan blades 210, a fan dome 215, and rotor bearings 220 for enabling rotation of the fan rotor 205. The motor 125 illustrated in FIGS. 2A-2D is a shaftless motor in that there is no output rotor shaft. The shaftless design distributes load more evenly to the bearing supports, reduces load-induced deflection on the rotor 205, and shifts the center of mass closer to the rotor center. An O-ring 225 is positioned adjacent the bearings 220 to reduce vibration and to isolate noise caused during operation of the motor 125. The motor 125 includes a stator 230 having an inner configuration, a rotor core 235, and rotor magnets 240. In some embodiments, the motor 125 does not include the rotor core 235. In such embodiments, the motor 125 can be considered a coreless motor 125 (e.g., including a Halbach array). In some embodiments, the rotor magnets are glued to the rotor 205 or overmolded to the rotor 205. A mounting bracket 245 is positioned to attach the motor 125 to the power tool 100, and power wires 250 connect the motor to the controller 120. In some examples, the power wires 250 connect the motor 125 to the switching module 155. In some examples, the mounting bracket 245 includes slots to fasten the motor 125 to a portion of the power tool 100.

The fan rotor 205 may be constructed from a plastic or aluminum construction, or other similar materials. In some examples, the fan rotor 205 is overmolded onto the motor 125. In other examples, the fan rotor 205 may be pressed, glued, heat staked, or otherwise affixed for rotation to the motor 125. The fan dome 215 supports the rotor bearings 220, enabling the rotation of the fan rotor 205. In some examples, the fan dome 215 is integrated as stationary and pressed to an inner diameter of the stator 230. In some examples, the fan dome 215 is stationary (e.g., integrated with the stator 230), such that the total rotating mass is reduced when compared to a rotating dome embodiment. A stationary fan dome may lower the polar inertia of the fan rotor 205 and decrease sensitivity to manufacturing imbalance. Additionally, the stationary dome may reduce inlet swirl (“curl”) upstream of the fan blades 210, promoting more laminar inflow and improving pressure-flow efficiency at equivalent tip speed. Furthermore, when the fan dome 215 is stationary, debris or particulate that may enter the fan housing cannot accumulate on a rotating surface. In contrast, with rotating-dome constructions, angularly uneven accumulation of such debris increases the rotating mass imbalance and may amplifies vibration at high speed. A stationary dome may reduce or eliminate this imbalance entirely and, because the dome does not rotate, overall durability is improved.

Stator windings 255 are wound around stator teeth 260 affixed to the stator 230. In addition to magnets 240 configured in a staggered North/South pole arrangement, magnetically perpendicular magnets 265 can be arranged between each North/South pole pair of magnets 240. The magnetically perpendicular magnets 265 are oriented such that the magnetic field generated on one side of the rotor is enhanced while the magnetic field generated on other side of the rotor is diminished. In other words, the perpendicular magnetic field generated by the magnetically perpendicular magnets 265 increases the magnetic field generated on an inner side 270 of the rotor core 235 while simultaneously reducing the magnetic field generated on an outer side 275 of the rotor core 235. The specific configuration and features of the magnets 240 and magnetically perpendicular magnets 265 is described in greater detail below.

With respect to the cross-sectional assembly of FIG. 2A, the structure of the motor 125 is configured to handle both axial and radial loads generated by the rotation of the fan blades 210. The rotor bearings 220 are spaced axially apart along the stationary mounting bracket 245, creating a cantilevered support structure that resists loads caused by gyroscopic forces or uneven airflow on the fan rotor 205. The O-ring 225 both dampens high-frequency vibrations transferred from the rotor 205 to the fan dome 215 and provides a seal to prevent debris from entering into the bearing race. Additionally, the mounting bracket 245 defines an internal hollow channel (illustrated in FIG. 2B) through which the power wires 250 are routed. With respect to FIG. 2B, the stator 230 is rigidly keyed (or, in some embodiments, press-fitted) onto the central mounting bracket 245. In some embodiments, the stator 230 acts as a heat sink, conducting thermal energy away from the windings 255 and into the bracket 245 where it may be dissipated through the tool housing. Conversely, the fan rotor 205 forms an outer surface formed by the fan dome 215. The rotor magnets 240 line the interior wall (not illustrated) of the fan rotor 205 such that the rotor magnets 240 are shielded from dust and impact by the structural material of the rotor 205 itself.

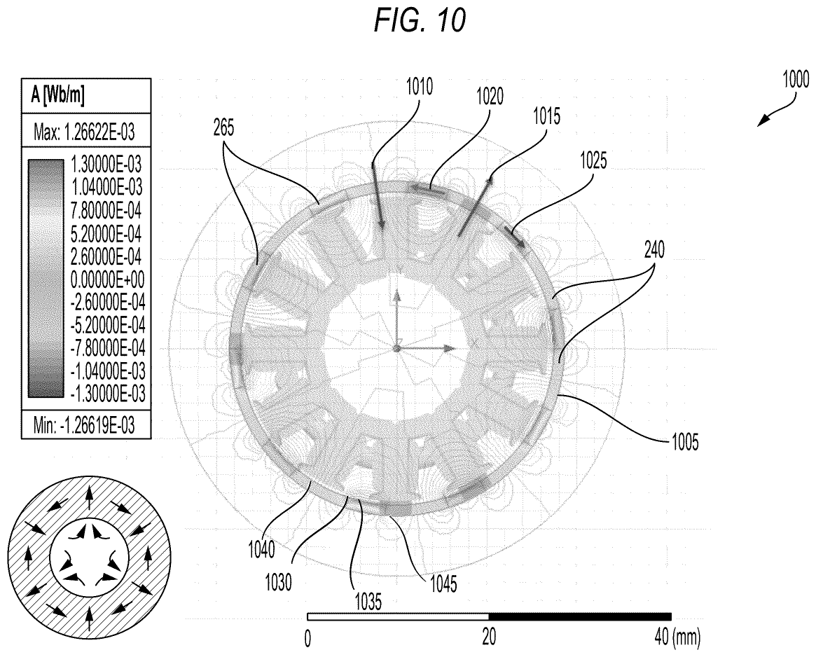

As shown in FIG. 2C, the profile of the motor 125 is such that the fan dome 215 features a continuous convex surface that, during operation, diverts intake air radially outward toward the surfaces of the fan blades 210. The power wires 250 extend axially from the rear of the mounting bracket 245 and are positioned to minimize disruption of the airflow entering or exiting the fan blades 210. FIG. 2D further illustrates the stator teeth 260 and stator windings 255 centrally with the fan rotor 205 separated circumferentially by an air gap. In some embodiments, the rotor core 235 serves as one of the flux return paths, as described in greater detail with respect to FIG. 10.

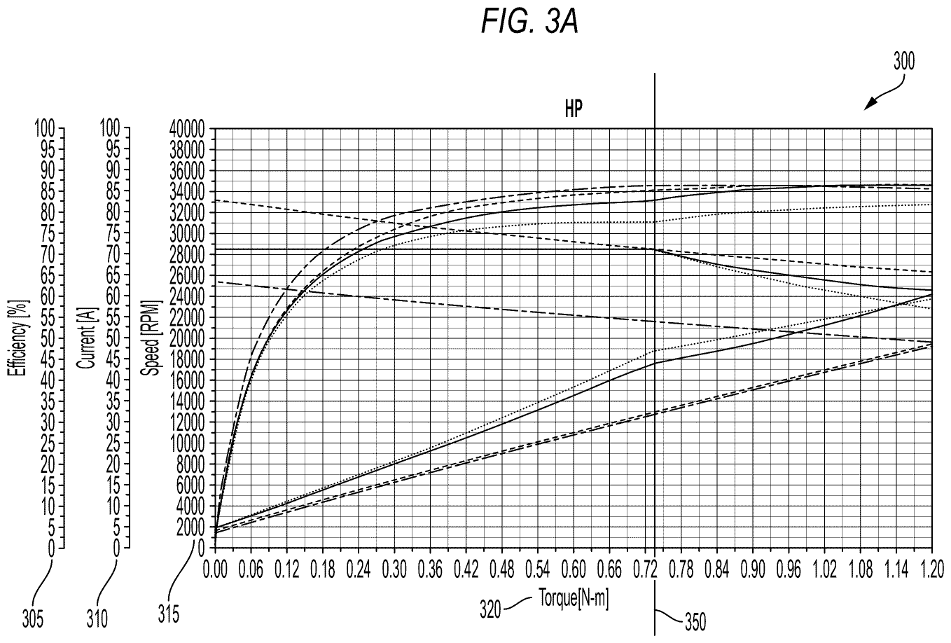

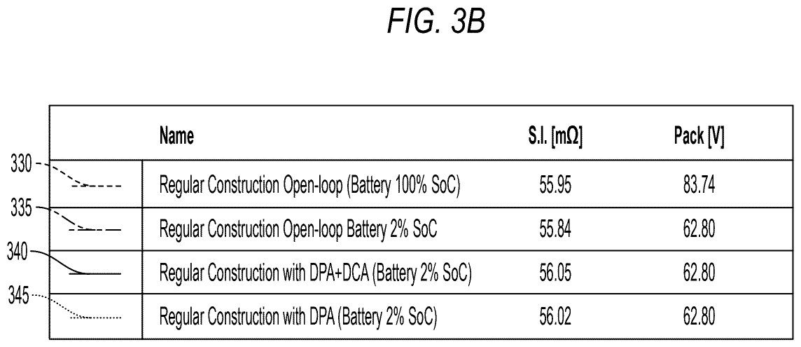

FIG. 3A is a graph 300 illustrating the performance characteristics of the motor 125 with respect to varies commutation control variations for the motor 125. FIG. 3B is the corresponding legend for the graph 300 of FIG. 3A. The graph 300 includes a Y-axis illustrating motor efficiency 305, motor current 310, and motor speed 315 and an X-axis illustrating motor torque output 320. The graph 300 illustrates a comparison between the regular construction open loop motor performance with a battery at a full (e.g., 100%) state of charge (trace 330), the regular construction open loop motor performance with a battery at a low (e.g., approximately 2%) state of charge (trace 335), the regular construction with both DPA+DCA with a battery at a low (e.g., approximately 2%) state of charge (trace 340), and the regular construction with only DPA trace 340 with a battery at a low (e.g., approximately 2%) state of charge (trace 345).

As indicated in the graph 300, there is a torque load point 350 at approximately 0.75 Nm that corresponds with the sustained load of the motor 125. At the torque load point 350, the efficiency of the motor of trace 330 and 335 are approximately equal, at about 85%. The efficiency of the motor of trace 340 is approximately 82.5%, and the efficiency of the motor of trace 345 is approximately 78.5%. At the torque load point 350, the current of the motor of trace 330 and 335 are also approximately equal, at about 32.5 Amps. The current of the motor of trace 340 is approximately 43 Amps, and the current of the motor of trace 345 is approximately 47 Amps. At the torque load point 350, the speed of the motor of trace 330, 340, and 345 are all approximately 28000 revolutions per minute (RPM), and the speed of the motor of trace 335 is approximately 23000 RPM.

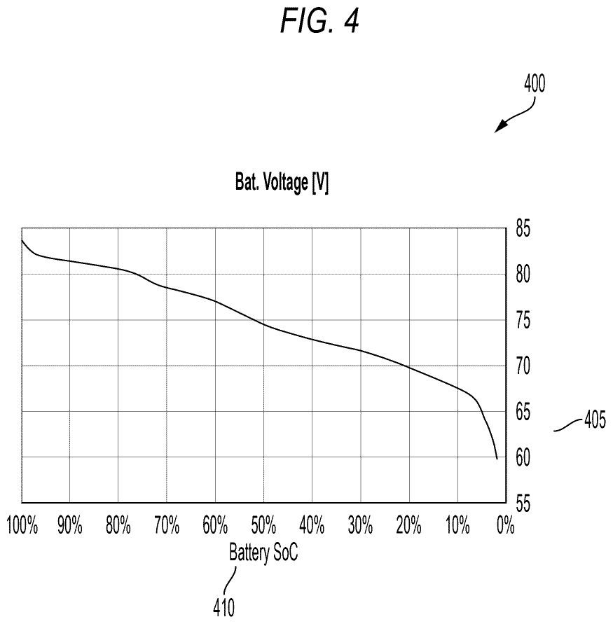

The graph 300 indicates that the performance of the DPA+DCA motor, as shown by trace 340 and the performance of the DCA motor, as shown by trace 345, yields more preferable results. In some examples, the DPA+DCA motor, as shown by trace 340, is the preferred option as it offers greater flexibility for increasing speed setpoints with a comparable system efficiency to the DPA counterpart, shown by trace 345. As detailed below, FIGS. 4-8 and their corresponding descriptions describe additional features of the power tool 100, battery pack 112, and motor 125 with respect to a variety of commutation control parameters described herein.

FIG. 4 is a graph 400 illustrating the performance characteristics of the battery pack 112 that provides power to the motor 125. The graph 400 includes a battery pack voltage 405 corresponding with a battery pack state-of-charge (SOC) percentage 410. In some embodiments, a battery pack state-of-charge of 100% is approximately 85V. In other embodiments, a battery pack state-of-charge value of 100% may correspond with other voltage values, such as 10.8V, 12V, 14.4V, 24V, 28V, 36V, 72V, 80V, 120V, 150V, between 10.8V or 150V. In graph 400, a battery pack state-of-charge value of 2% is approximately 60V. As indicated in the graph 400, the state-of-charge of the battery of the battery generally decreases approximately linearly with a corresponding decrease in voltage of the battery pack 112.

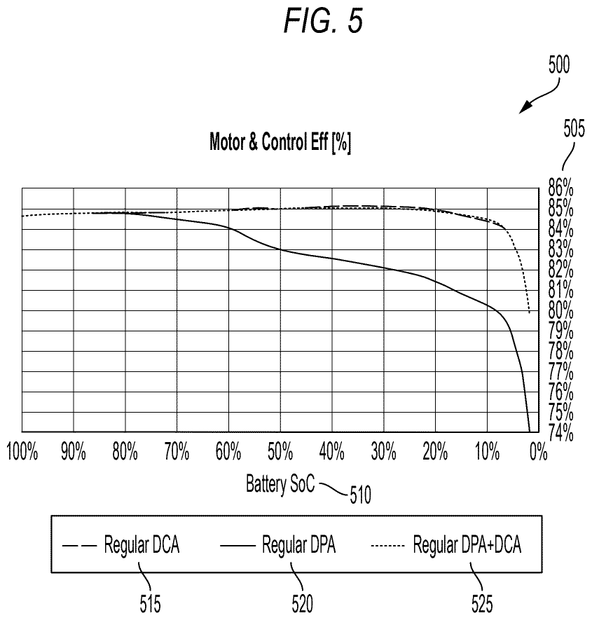

FIG. 5 is a graph 500 illustrating the motor and control efficiency 505 of the motor 125 when compared with the battery pack state-of-charge 510. The graph 500 includes a regular DCA motor efficiency trace 515, a regular DPA efficiency trace 520, and a regular DPA+DCA efficiency trace 525. As shown in the graph 500, all three traces 515, 520, 525 perform at approximately the same efficiency level of 85% between a battery pack state-of-charge of 100% and 75%. At approximately 75%, the regular DPA efficiency trace diminishes in efficiency while the regular DCA efficiency trace 515 and the regular DPA+DCA trace 525 continue to be equally efficient at approximately 85%. At a battery pack state-of-charge level of approximately 10%, the regular DPA efficiency has been reduced to 80% while the regular DCA efficiency and the regular DPA+DCA are both over 84%.

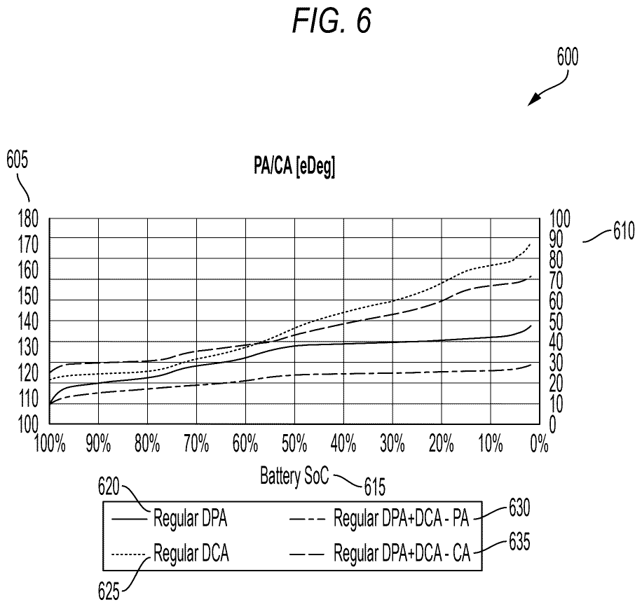

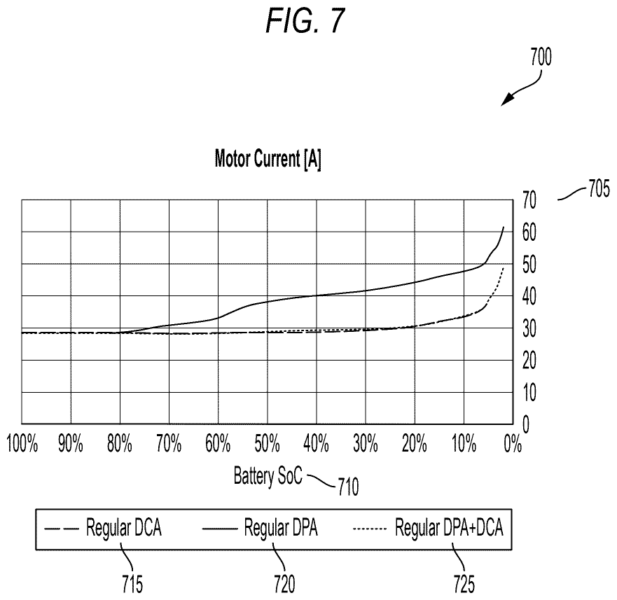

FIG. 6 is a graph 600 illustrating the performance characteristics of the motor 125. The graph 600 includes the commutation angle (“CA”) 605 and the phase advance angle (“PA”) 610, in degrees, compared with the battery pack state-of-charge 615. The graph 600 includes a regular DPA trace 620, a regular DCA trace 625, a regular DPA+DCA-PA trace 630, and a regular DPA+DCA-CA trace 635. FIG. 7 is a graph 700 illustrating the motor 125 current in Amperes 705 compared with the battery pack state-of-charge 710. The graph 700 includes a regular DCA trace 715, a regular DPA trace 720, and a regular DPA+DCA trace 725. As illustrated in the graph 700, the regular DPA trace 720 and regular DPA+DCA trace 725 perform approximately the same between 100% battery pack state-of-charge and 20% battery pack state-of-charge, at approximately 30 amps. The regular DPA trace 720 deviates from 30 amps at approximately 75% state-of-charge, increasing to approximately 45 amps at 20% battery pack state-of-charge.

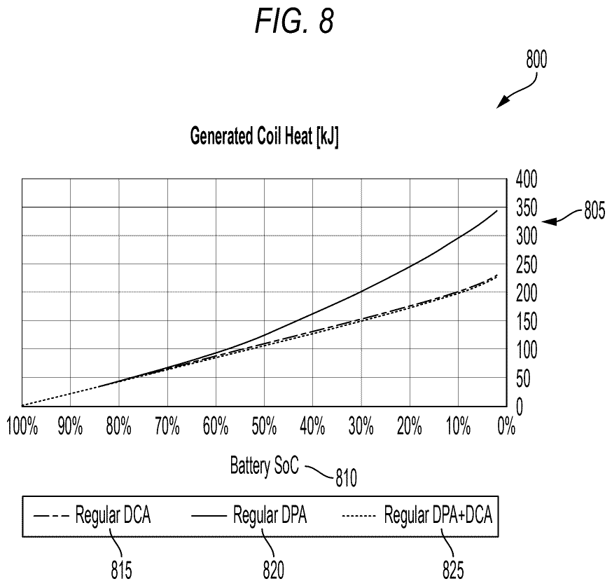

FIG. 8 is a graph 800 illustrating the coil heat of the motor 125 in kilojoules 805 compared to the battery pack state-of-charge 810. The graph 800 includes a regular DCA trace 815, a regular DPA trace 820, and a regular DPA+DCA-PA trace 825. As shown in the graph 800, the motor 125 coil heat between all traces 815, 820, 825 is approximately the same between 100% battery pack state-of-charge 810 and approximately 70% battery pack state-of-charge 810. At 60% battery pack state-of-charge 810, the regular DPA trace 820 deviates from the regular DCA trace 815 and the regular DPA+DCA trace 825, with the motor 125 coil heat increasing at a faster rate with the decreasing battery pack state-of-charge 810.

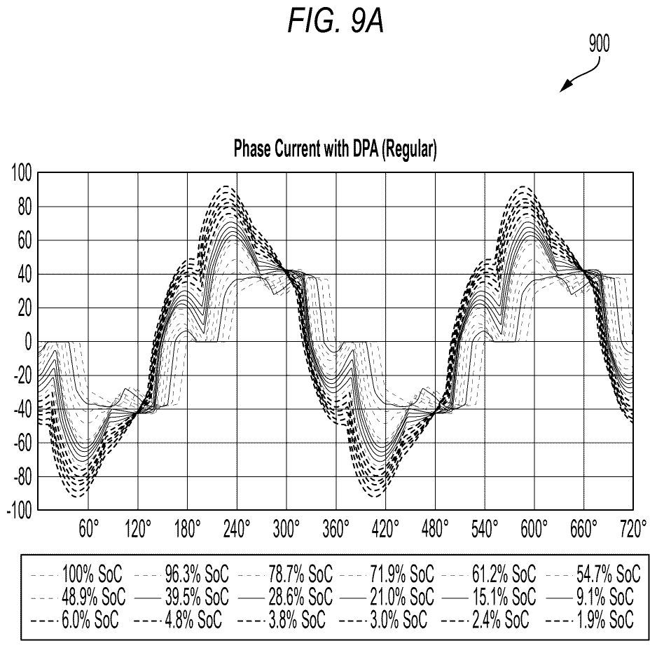

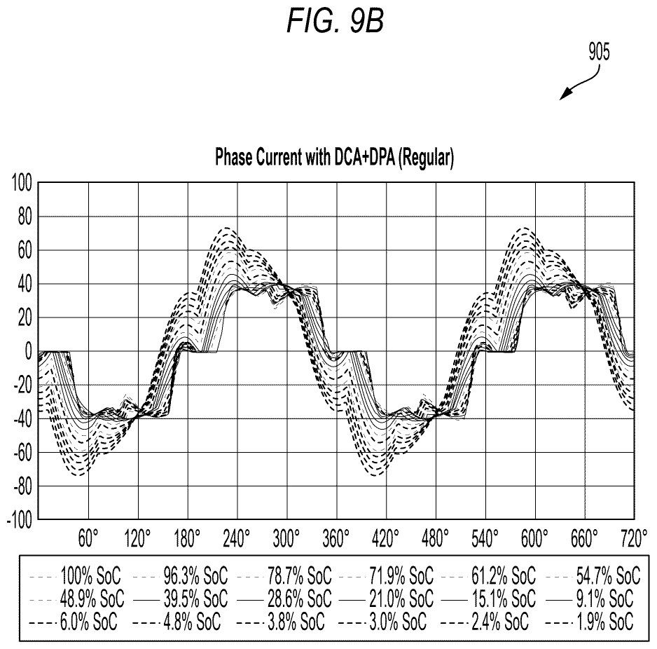

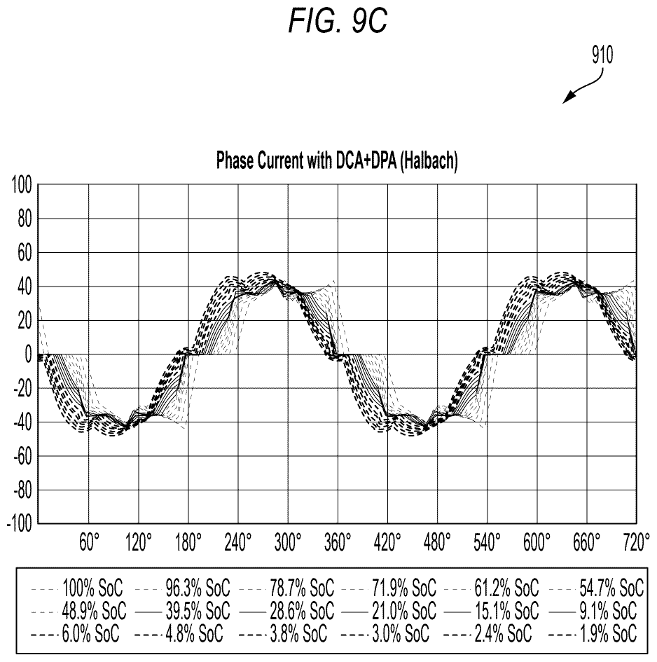

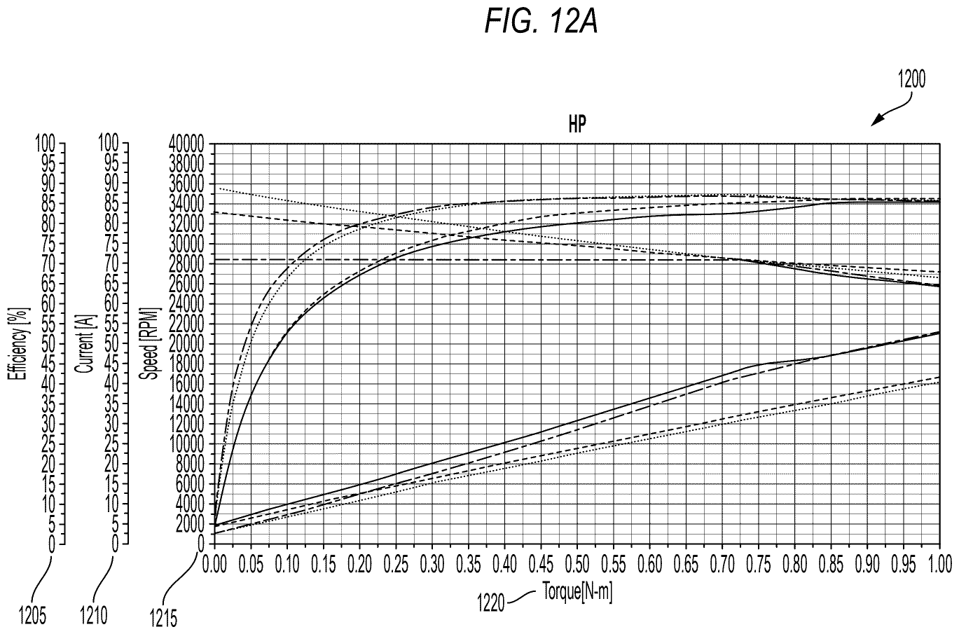

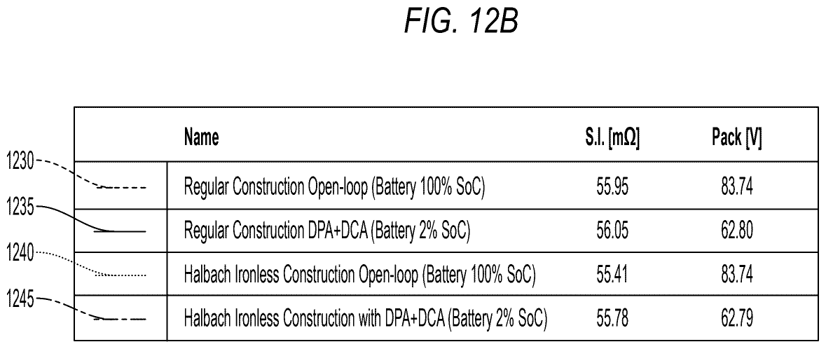

FIGS. 9A, 9B, and 9C are three graphs illustrating the performance characteristics of a motor 125, in accordance with embodiments described herein. Graph 900 illustrates the phase current of a regular construction motor using DPA control. Graph 905 illustrates the phase current of a regular construction motor using DCA+DPA control. Graph 910 illustrates the phase current of a Halbach motor using DCA+DPA control. As illustrated in FIGS. 9A-9C, the phase current of the regular construction motor using both DCA+DPA control is generally more sinusoidal in form. By applying the DCA+DPA control to a Halbach motor, the waveform is made considerably more sinusoidal, as shown in graph 910. The more sinusoidal waveform of the DCA+DPA control reduces the harmonic content and torque ripple in the motor 125. In some examples, this is particularly important. When he back EMF follows a nearly perfect sine wave, the controller 120 applying vector control (e.g., the dynamically adjusted phase angle) can more accurately modulate the motor current amplitude and phase to weaken the field. This improved controllability allows the motor 125 to seamlessly transition to higher speeds without running into significant saturation or inefficient current flow, as will be illustrated in FIG. 12.

FIG. 10 illustrates a cross-sectional view 1000 of the motor 125 configured as a Halbach motor. As previously described, the motor 125 includes a magnet array 1005 including magnets 240 and magnetically perpendicular magnets 265. The magnets 240 are arranged in pole pairs, with one of the magnets 240 generating a field in a first direction 1010 (e.g. a north pole) and another of the magnets 240 generating a field in a second direction 1015 (e.g., a south pole) that is opposite from the first direction 1010. The magnetically perpendicular magnets 265 are positioned between each of the magnets 240 and are also configured in pole pairs. One of the pole pairs of magnetically perpendicular magnets 265 is positioned to generate a first perpendicular magnetic field in a first perpendicular direction 1020 and the other of the pole pairs of the magnetically perpendicular magnets 265 is positioned to generate a first perpendicular magnetic field in a second perpendicular direction 1025.

The magnet array 1005 is arranged such that each segment's magnetization direction is progressively rotated, creating a flux path that maximizes the magnetic field on one side and nearly cancels it on the other. For example, as illustrated in the cross-sectional view 1000, the field in the first direction 1010 is generally greater in strength than the field in the second direction 1015. In some examples, by varying the number of segments of the magnet array 1005, magnet material properties, and/or orientations, the amplitude and distribution of magnetic flux can be varied. Higher flux densities in the stator 230 yield increased torque and faster motor response, as shown in the performance graphs disclosed herein. In some examples, reducing the peak flux by adjusting magnet thickness or spacing may mitigate eddy-current loss and/or lower temperature rise.

As illustrated in FIG. 10, the flux lines 1030 depict the magnetic field, where the dense clustering of flux lines within an inner diameter 1040 of the rotor indicates a region of high magnetic flux density directed into the working air gap 1035. Conversely, the distribution of flux lines 1030 on an exterior diameter 1045 indicates effective magnetic field cancellation produced by the magnetically perpendicular magnets 265. By orienting the magnetic vectors of the perpendicular magnets 265 tangentially or circumferentially between the radially magnetized magnets 240, the magnetic circuit is oriented through the magnet material itself. As a consequence, the fan rotor 205 may be constructed from lightweight, non-magnetic materials without suffering from flux leakage.

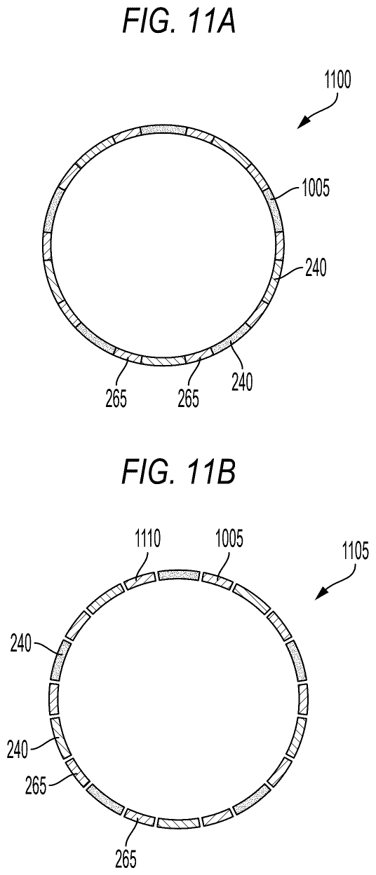

FIGS. 11A and 11B illustrate an arrangement of magnets in the magnet array 1005 of the motor 125. The magnet array 1005 may be configured on a solid magnet ring, a segmented full ring 1100, or on a segmented ring 1105 with spaces 1110 between each of the magnets 240 and magnetically perpendicular magnets 265. In some examples, the spaces 1110 may provide additional cost savings by reducing an amount of required magnetic material used in the magnets 240 and magnetically perpendicular magnets 265. In some examples, spaces 1110 may be located intermittently between each of the magnets 240 and magnetically perpendicular magnets 265, or spread out such that not every magnet 240 and magnetically perpendicular magnet 265 includes an adjacent space 1110.

FIG. 12A is a graph 1200 illustrating the performance characteristics of a Halbach motor, such as motor 125, when compared with a regular construction brushless DC motor. FIG. 12B is the corresponding legend for the graph 1200 of FIG. 12A. The graph 1200 includes a Y-axis illustrating motor efficiency 1205, motor current 1210, and motor speed 1215 and an X-axis illustrating motor torque output 1220. The graph 1200 illustrates a comparison between the regular construction open loop motor performance with a battery at a full (e.g., 100%) state of charge (trace 1230), the regular construction DPA+DPA motor performance with a battery at a low (e.g., approximately 2%) state of charge (trace 1235), the Halbach construction with open loop control with a battery at full (e.g., 100%) state of charge (trace 1240), and the Halbach construction with both DPA+DCA control with a battery at a low (e.g., approximately 2%) state of charge (trace 1245). The efficiency 1205 of Halbach motor using either the open loop or the DPA+DCA control, traces 1240,1245, is greater than both the open loop and DPA+DCA control of the regular brushless motor, traces 1230, 1235.

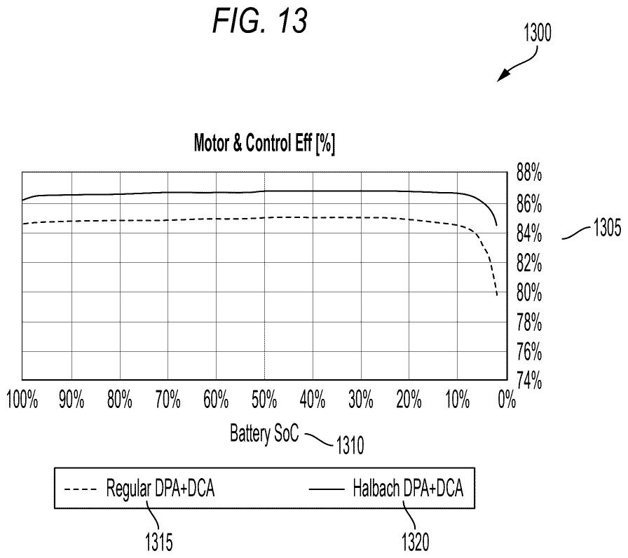

FIG. 13 is a graph 1300 illustrating a comparison of a Halbach motor, such as motor 125, when compared with a regular construction brushless DC motor. The graph 1300 includes the motor and control efficiency 1305 compared with a battery pack state-of-charge 1310 for both a regular construction brushless DC motor using DPA+DCA control, trace 1315, and a Halbach motor using DPA+DCA control, trace 1320. As illustrated in the graph 1300, the Halbach motor performs at a higher efficiency level at every battery pack state-of-charge percentage.

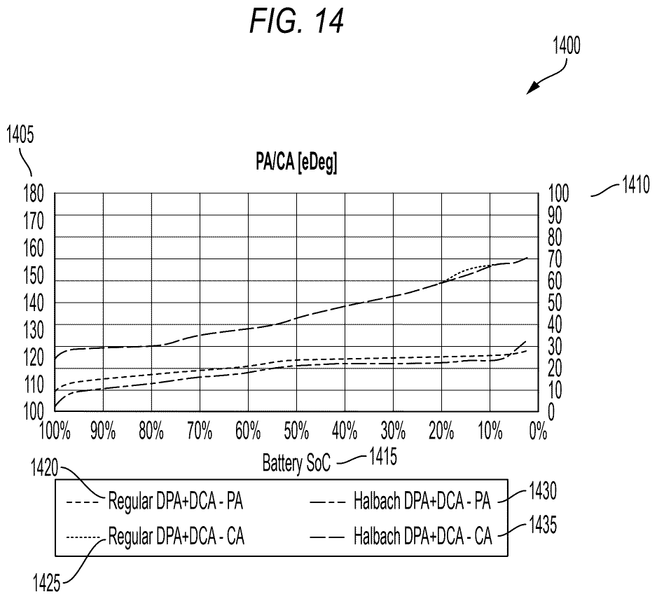

FIG. 14 is a graph 1400 illustrating the performance characteristics of the motor 125. The graph 1400 includes the commutation angle (“CA”) 1405 and the phase advance angle (“PA”) 1410, in degrees, compared with the battery pack state-of-charge 1415. The graph 1400 includes a regular motor DPA+DCA-PA trace 1420, a regular motor DPA+DCA-CA trace 1425, a Halbach motor DPA+DCA-PA trace 1430, and a Halbach DPA+DCA-CA trace 1435.

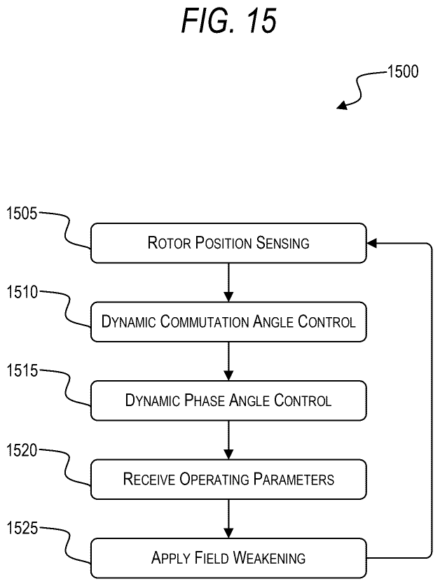

FIG. 15 is a flowchart of a process 1500 for controlling a motor, such as motor 125. The process 1500 includes receiving a rotor position (step 1505), via a position sensor, such as from sensors 135, to detect the instantaneous angular position of the rotor. Once the rotor's position is detected, the sensors 135 output corresponding signals that represent rotor angle position to the controller 120. The controller 120 uses the positional data to ensure each subsequent control action is synchronized to optimize the electromagnetic coupling within the motor 125. In some examples, the rotor position data may be filtered or otherwise conditioned to remove electrical or mechanical noise. The process 1500 continues to determine a commutation angle (step 1510) for each of the phases of the motor 125 based on the rotor position data. The controller 120 uses the rotor position data to calculate the correct commutation angle for each stator phase. This calculation includes the Halbach magnet array 1005 pole structure and the desired operating setpoint for torque or speed. In some examples, the controller 120 defines conduction intervals that align stator current with the fan rotor 205 magnetic field to maximize torque production or motor 125 efficiency.

The process 1500 includes dynamically controlling the commutation angle by selectively advancing or delaying conduction intervals of each phase. For example, after initially determining the commutation angles, the controller 120 may continuously refine the commutation angles in real time (e.g., dynamically adjusting the angles). The controller 120 advances or delays the start or end of conduction intervals for each phase to accommodate changes in load and/or speed of the motor or voltage supply to the motor. By adjusting the precise timing of current application, the controller 120 reduces torque ripple, improves motor efficiency, and maintains stable performance as motor conditions change.

The process 1500 includes dynamically controlling a phase angle (step 1515) of the motor by modulating the phase of a motor current relative to a rotor magnetic field. In some examples, the controller also controls the phase of the stator current vector simultaneously with the commutation angle adjustments of step 1510. In other examples, the controller 120 performs step 1510 and step 1515 sequentially in any order. In step 1515, the controller manipulates the instantaneous angle of the motor current relative to the magnetic flux generated by the fan rotor 205. During lower-speed, high-torque conditions, the controller 120 may shift the motor current to maximize torque output. At higher speeds, the controller may advance the current to weaken the magnetic field, thereby allowing the motor 125 to reach higher speeds without excessive current draw.

The process 1500 includes receiving an operating parameter of the motor 125, the battery pack 112, or another parameter of the power tool 100 (step 1520). The controller 120 continuously gathers operational data, such as motor speed, motor current, motor temperature, battery pack voltage, battery pack temperature, or other power tool parameters. The controller 120 uses the operating parameters to determine if additional control, further optimization, or a transition to a different operating mode, such as field weakening, may be warranted. When the controller 120 determines that further control is warranted, the controller 120 applies a combined field weakening control to the motor 125 by implementing the combined dynamically adjusted commutation angles (“DCA”) and the dynamically adjusted phase angles (“DPA”) in response to the received operating parameter (step 1525). For examples, when the received operating parameter indicates that the motor 125 speed range or torque level are below a threshold, the controller can apply both DCA and DPA controls together. By jointly manipulating conduction timing and current phase, the controller 120 ensures the motor 125 sustains higher rotational speeds while maintaining operational efficiency, thermal stability, and performance. In some operating modes, the controller 120 maintains a substantially constant target speed as battery pack state-of-charge decreases by coordinating phase advance with commutation-angle adjustment. By offsetting the decline in bus voltage with DPA and DCA, the motor sustains the selected speed setpoint over a wide state of charge window without excessive current increase.

As described above, the Halbach magnet array 1005 of the motor 125 intensifies magnetic flux on the stator-facing side, enabling more effective torque generation even when the flux is reduced for high-speed operation. By using the process 1500 for controlling the motor 125, a stronger and more uniform magnetic field is generated in the desired direction. This intensified field also simplifies the implementation of flux-weakening techniques, allowing the motor 125 to sustain higher speeds while maintaining productive torque output. Additionally, because the magnet array 1005 raises the back EMF at lower currents, the motor 125 can produce the same torque with reduced current when compared with a more traditional (e.g., regular) motor construction. The uniform magnetic field of the motor 125 also gives the controller 120 finer control over the phase current, aiding in precise conduction and phase angle adjustments.

The Halbach configuration of the motor 125 enables the conduction angle of each stator phase to be extended without incurring substantial losses. In some examples, the motor 125 delivers higher torque across a broader speed range because the magnetic field holds up even at higher rotational rates. In some examples, the longer conduction periods generate strong torque with reduced current requirements, thereby improving overall efficiency of the motor and extending battery pack life. Additionally, the increased back EMF produced by the magnet array 1005 of the motor 125 complement a higher phase advance angle, more efficiently aligning the stator current with the modified magnetic field. This alignment boosts torque generation without pushing current levels into inefficient ranges, as demonstrated in FIGS. 12-13.

The improved phase advance angle maintains a more sinusoidal current waveform, diminishing harmonic losses and contributing to smoother, more efficient motor operation. Because the magnet array 1005 cancels much of the flux on the outer side 275, the rotor core 235 channels flux lines more effectively. This can allow the rotor core to be thinned out, replaced with non-magnetic material, or even removed in some embodiments (e.g., motor 125). In some examples, when the motor is operating at high electrical frequencies, where iron losses become significant, the reduced or removed rotor core elements can further increase efficiency and lower overall weight, thus enhancing the motor 125's power-to-weight ratio.

### REPRESENTATIVE FEATURES

Representative features are set out in the following clauses, which stand alone or may be combined, in any combination, with one or more features disclosed in the text and/or drawings of the specification.
Clause 1. A power tool comprising: a motor including a stator and a rotor, the stator having an inner configuration, the stator including a plurality of stator windings wound around a plurality of stator teeth; the rotor is mounted for rotation relative to the stator, the rotor including rotor magnets positioned on the rotor in a magnet array, the magnet array including magnetically perpendicular magnets arranged between adjacent rotor magnets such that a first magnetic field on an inner side of the rotor is greater than a second magnetic field on an outer side of the rotor, the rotor including a plurality of fan blades, a fan dome, and rotor bearings supported by the fan dome; a mounting bracket configured to attach the motor to the power tool; a position sensor configured to sense a position of the rotor and to generate rotor position data; and an electronic processor connected to the motor and the position sensor, the electronic processor is configured to: determine a commutation angle for each of a plurality of phases of the stator based on the rotor position data, dynamically control the commutation angle of the motor by selectively advancing or delaying conduction intervals of each phase, dynamically control a phase advance angle of the motor by modulating the phase advance angle of a motor current relative to a magnetic field of the magnet array, receive an operating parameter of the power tool, and apply a combined field weakening to the motor by implementing the dynamically controlled commutation angle and the dynamically controlled phase advance angle in response to the operating parameter.
Clause 2. The power tool of clause 1, wherein the motor is a shaftless motor, and wherein the mounting bracket includes a stationary support within the stator, the rotor bearings being positioned between the stationary support and the fan dome to rotatably support the rotor around the stator.
Clause 3. The power tool of any preceding clause, wherein the magnet array is configured as a Halbach array, and wherein the magnetically perpendicular magnets are oriented to concentrate magnetic flux on the inner side of the rotor toward the stator while canceling magnetic flux on the outer side of the rotor.
Clause 4. The power tool of any preceding clause, wherein the magnet array is arranged on a segmented ring defining a plurality of spaces, wherein each space of the plurality of spaces is positioned between one of the rotor magnets and an adjacent one of the magnetically perpendicular magnets.
Clause 5. The power tool of any preceding clause, wherein the operating parameter is one selected from the group consisting of a motor speed, a motor current, a motor temperature, a battery pack voltage, and a battery pack temperature.
Clause 6. The power tool of any preceding clause, wherein the electronic processor further configured to: dynamically control the commutation angle by modifying an electrical conduction boundary of the motor such that each stator winding is energized at a predetermined rotor angle.
Clause 7. The power tool of any preceding clause, the electronic processor further configured to: dynamically control the phase advance angle by continuously shifting a current phase of the motor relative to a motor voltage.
Clause 8. The power tool of any preceding clause, the electronic processor further configured to: apply the combined field weakening in response to the received operating parameter indicating that a speed of the motor is below a speed threshold.
Clause 9. The power tool of any preceding clause, the electronic processor further configured to: apply the combined field weakening in response to the received operating parameter indicating that a torque level of the motor is below a torque threshold.
Clause 10. The power tool of any preceding clause, wherein the power tool is a blower, the blower including a backpack portion and an arm portion.
Clause 11. A method of controlling a motor, the motor including a rotor having a Halbach magnet array and a stator in electromagnetic communication with the rotor, the method comprising: sensing, via a position sensor, a position of the rotor; generating, via the position sensor, rotor position data; determining, via an electronic processor, a commutation angle for each of a plurality of phases of the stator based on the rotor position data; dynamically controlling, via the electronic processor, the commutation angle of the motor by selectively advancing or delaying conduction intervals of each phase; dynamically controlling, via the electronic processor, a phase advance angle of the motor by modulating the phase advance angle of a motor current relative to a rotor magnetic field; receiving, via the electronic processor, an operating parameter; and applying, to the motor and via the electronic processor, a combined field weakening by implementing the dynamically controlled commutation angle and the dynamically controlled phase advance angle in response to the operating parameter.
Clause 12. The method of clause 11, wherein receiving the operating parameter includes receiving at least one selected from the group consisting of a motor speed, a motor current, a motor temperature, a battery pack voltage, and a battery pack temperature.
Clause 13. The method of clauses 11 or 12, wherein dynamically controlling the commutation angle includes modifying an electrical conduction boundary of the motor such that each stator winding is energized at a predetermined rotor angle relative to a position of the rotor.
Clause 14. The method of any of clauses 11-13, wherein dynamically controlling the phase advance angle includes continuously shifting a current phase of the motor relative to a motor voltage.
Clause 15. The method of any of clauses 11-14, wherein applying the combined field weakening includes simultaneously shifting a stator current vector phase.
Clause 16. The method of any of clauses 11-15, further comprising: determining, via the electronic processor, when the operating parameter indicates that a speed of the motor is below a speed threshold or a torque level of the motor is below a torque threshold, and applying, in response to the speed of the motor being below the speed threshold or the torque level of the motor being below the torque threshold, to the motor and via the electronic processor, the combined field weakening by implementing the dynamically controlled commutation angle and the dynamically controlled phase advance angle.
Clause 17. The method of any of clauses 11-16, wherein dynamically controlling the phase advance angle includes advancing the motor current to weaken the rotor magnetic field when the operating parameter indicates a high-speed condition.
Clause 18. A motor comprising: a stationary support structure configured to be coupled to a housing; a stator mounted to the stationary support structure, the stator including a plurality of stator teeth and a plurality of stator windings wound around the plurality of stator teeth; an outer rotor configured to rotate relative to the stator, the outer rotor having at least one bearing positioned between the stationary support structure and the rotor to rotatably support the outer rotor; and a Halbach magnet array coupled to an inner surface of the outer rotor, the Halbach magnet array including: a first magnet configured to generate a first magnetic field, and a second magnet arranged adjacent the first magnet, the second magnet being magnetically perpendicular to the first magnet; wherein the Halbach magnet array is configured to concentrate a magnetic flux radially toward the stator windings and substantially cancel the magnetic flux radially away from the stator.
Clause 19. The motor of clause 18, wherein the first magnet is configured to generate the first magnetic field in a radial direction of the motor.
Clause 20. The motor of clause 18 or 19, further comprising: an O-ring positioned adjacent to the at least one bearing, wherein the outer rotor further includes a plurality of fan blades and a fan dome positioned on the outer rotor, wherein the at least one bearing is supported by the fan dome to enable rotation of the rotor, and wherein the O-ring is configured to reduce vibration generated by the rotation of the rotor.

Although the disclosure has been described in detail with reference to certain preferred embodiments, variations and modifications exist within the scope and spirit of one or more independent aspects of the disclosure as described. Various features and advantages are set forth in the following claims.

What is claimed is:

1. A power tool comprising:
a motor including a stator and a rotor, the stator having an inner configuration, the stator including a plurality of stator windings wound around a plurality of stator teeth;
the rotor is mounted for rotation relative to the stator, the rotor including rotor magnets positioned on the rotor in a magnet array, the magnet array including magnetically perpendicular magnets arranged between adjacent rotor magnets such that a first magnetic field on an inner side of the rotor is greater than a second magnetic field on an outer side of the rotor, the rotor including a plurality of fan blades, a fan dome, and rotor bearings supported by the fan dome;
a mounting bracket configured to attach the motor to the power tool;
a position sensor configured to sense a position of the rotor and to generate rotor position data; and
an electronic processor connected to the motor and the position sensor, the electronic processor is configured to:
determine a commutation angle for each of a plurality of phases of the stator based on the rotor position data,
dynamically control the commutation angle of the motor by selectively advancing or delaying conduction intervals of each phase,
dynamically control a phase advance angle of the motor by modulating the phase advance angle of a motor current relative to a magnetic field of the magnet array,
receive an operating parameter of the power tool, and
apply a combined field weakening to the motor by implementing the dynamically controlled commutation angle and the dynamically controlled phase advance angle in response to the operating parameter.

2. The power tool of claim 1, wherein the motor is a shaftless motor, and wherein the mounting bracket includes a stationary support within the stator, the rotor bearings being positioned between the stationary support and the fan dome to rotatably support the rotor around the stator.

3. The power tool of claim 1, wherein the magnet array is configured as a Halbach array, and wherein the magnetically perpendicular magnets are oriented to concentrate magnetic flux on the inner side of the rotor toward the stator while canceling magnetic flux on the outer side of the rotor.

4. The power tool of claim 1, wherein the magnet array is arranged on a segmented ring defining a plurality of spaces, wherein each space of the plurality of spaces is positioned between one of the rotor magnets and an adjacent one of the magnetically perpendicular magnets.

5. The power tool of claim 1, wherein the fan dome is a stationary fan dome further configured to prevent rotating mass imbalance caused by angularly uneven accumulation of debris on a surface of the fan dome.

6. The power tool of claim 1, wherein the electronic processor further configured to:
dynamically control the commutation angle by modifying an electrical conduction boundary of the motor such that each stator winding is energized at a predetermined rotor angle.

7. The power tool of claim 1, the electronic processor further configured to:
dynamically control the phase advance angle by continuously shifting a current phase of the motor relative to a motor voltage.

8. The power tool of claim 1, the electronic processor further configured to:
apply the combined field weakening in response to the received operating parameter indicating that a speed of the motor is below a speed threshold.

9. The power tool of claim 1, the electronic processor further configured to:
apply the combined field weakening in response to the received operating parameter indicating that a torque level of the motor is below a torque threshold.

10. The power tool of claim 1, wherein the power tool is a blower, the blower including a backpack portion and an arm portion.

11. A method of controlling a motor, the motor including a rotor having a Halbach magnet array and a stator in electromagnetic communication with the rotor, the method comprising:
sensing, via a position sensor, a position of the rotor;
generating, via the position sensor, rotor position data;
determining, via an electronic processor, a commutation angle for each of a plurality of phases of the stator based on the rotor position data;
dynamically controlling, via the electronic processor, the commutation angle of the motor by selectively advancing or delaying conduction intervals of each phase;
dynamically controlling, via the electronic processor, a phase advance angle of the motor by modulating the phase advance angle of a motor current relative to a rotor magnetic field;
receiving, via the electronic processor, an operating parameter; and
applying, to the motor and via the electronic processor, a combined field weakening by implementing the dynamically controlled commutation angle and the dynamically controlled phase advance angle in response to the operating parameter.

12. The method of claim 11, wherein receiving the operating parameter includes receiving at least one selected from the group consisting of a motor speed, a motor current, a motor temperature, a battery pack voltage, and a battery pack temperature.

13. The method of claim 11, wherein dynamically controlling the commutation angle includes modifying an electrical conduction boundary of the motor such that each stator winding is energized at a predetermined rotor angle relative to a position of the rotor.

14. The method of claim 11, wherein dynamically controlling the phase advance angle includes continuously shifting a current phase of the motor relative to a motor voltage.

15. The method of claim 11, wherein applying the combined field weakening includes simultaneously shifting a stator current vector phase.

16. The method of claim 11, further comprising:
determining, via the electronic processor, when the operating parameter indicates that a speed of the motor is below a speed threshold or a torque level of the motor is below a torque threshold, and
applying, in response to the speed of the motor being below the speed threshold or the torque level of the motor being below the torque threshold, to the motor and via the electronic processor, the combined field weakening by implementing the dynamically controlled commutation angle and the dynamically controlled phase advance angle.

17. The method of claim 11, wherein dynamically controlling the phase advance angle includes advancing the motor current to weaken the rotor magnetic field when the operating parameter indicates a high-speed condition.

18. A motor comprising:
a stationary support structure configured to be coupled to a housing;
a stator mounted to the stationary support structure, the stator including a plurality of stator teeth and a plurality of stator windings wound around the plurality of stator teeth;
an outer rotor configured to rotate relative to the stator, the outer rotor having at least one bearing positioned between the stationary support structure and the outer rotor to rotatably support the outer rotor; and
a Halbach magnet array coupled to an inner surface of the outer rotor, the Halbach magnet array including:
a first magnet configured to generate a first magnetic field, and
a second magnet arranged adjacent the first magnet, the second magnet being magnetically perpendicular to the first magnet;
wherein the Halbach magnet array is configured to concentrate a magnetic flux radially toward the plurality of stator windings and substantially cancel the magnetic flux radially away from the stator.

19. The motor of claim 18, further comprising a stationary fan dome coupled to the stator, the stationary fan dome configured to prevent rotating mass imbalance caused by angularly uneven accumulation of debris on a surface of the fan dome.

20. The motor of claim 18, further comprising:
an O-ring positioned adjacent to the at least one bearing,
wherein the outer rotor further includes a plurality of fan blades and a fan dome positioned on the outer rotor, and
wherein the at least one bearing is supported by the fan dome to enable rotation of the outer rotor,
wherein the O-ring is configured to reduce vibration generated by the rotation of the outer rotor.
